(19) United States
(12) Patent Application Publication
(10) Pub. No.: US 2017/0013994 A1
(43) Pub. Date: Jan. 19, 2017

(54) MULTIPLE HEIGHT PLATFORM

(71) Applicant: C.A. Ronan & Co., Inc., Pound Ridge, NY (US)

(72) Inventors: Christopher A. Ronan, Pound Ridge, NY (US); Paul Ronan, Seattle, WA (US)

(73) Assignee: C.A. Ronan & Co., Inc., Pound Ridge, NY (US)

(21) Appl. No.: 14/801,287

(22) Filed: Jul. 16, 2015

(51) Int. Cl. A47J 31/44; A47J 31/46

(52) U.S. Cl. CPC A47J 31/4403; A47J 31/46

(57) ABSTRACT

A device to raise a vessel placed in a liquid dispensing machine to a proper height to avoid spillage/splashing while filling the vessel with liquid. The multiple height platform include a shelf surrounded by an outer wall. The shelf is positioned at a height other than one-half the total height of the outer wall. Thus depending on which side of the multiple height platform is placed under the liquid dispenser the shelf and the vessel placed on it can be at 2 different heights. In one design there is an opening in the outer wall to allow a handle for the vessel to extend beyond the wall. Another variation of the multiple height platform the outer wall include a portion which is extendable to allow the variation in the size of the opening in the outer wall.

### BACKGROUND

The disclosed multiple height platform is a beverage utensil but it can also be configured and used in other applications. It is intended to enhance the performance and operation of a typical single-serve coffee brewing machine, such as the Keurig® brand machines. Typical single-serve coffee brewing machines, as they currently exist, have a stationary tray situated beneath the coffee dispenser, on which a receptacle (typically a traditional cup or mug) is placed to receive the coffee (or other liquid beverage) produced by the machine.

The problem the multiple height platform seeks to solve is that the difference in height between the tray and the dispenser is often so great that when the coffee (or other beverage) is released from the dispenser and into the receptacle, it splashes out from the receptacle.

### SUMMARY OF THE INVENTION

A multiple height platform is disclosed and claimed which may be placed upon the tray of a liquid dispensing machine, allowing for an adjustment of the height of the receptacle relative to the dispenser. This platform thereby provides enhanced performance of liquid dispensing machine such as the single-serve coffee machine. This platform configuration among other things, minimizes splashing of the coffee (or other liquid) being dispensed. This new device may also be designed and used for any other liquid dispensing machines such as for soda, juice, beer, or water. Experimental use of the multiple height platform has resulted in less splatter during the use of a single-serve coffee brewing system.

### DESCRIPTION OF THE DRAWINGS

FIG. 1 depicts one embodiment with the outer wall surrounding the shelf.

FIG. 2 depicts one embodiment with the outer wall surrounding only a portion of the shelf.

FIG. 3 depicts one embodiment with the outer wall including an extendable portion.

### PARTS LIST

1—outer wall
2—shelf
3—upper end of outer wall
4—lower end of outer wall
5—mid-height in outer wall
6—orifice
7—extendable outer wall portion
8—outer wall pocket

### DETAILED DESCRIPTION

Disclosed and claimed is a multiple height or dual-height platform. In one embodiment it may be configured for placement upon the tray of a typical single-serve coffee machine. Typical single-serve coffee brewing machines, as they currently exist, have a stationary tray situated beneath the liquid dispenser, on which a receptacle/vessel/container (typically a cup or mug) is placed to receive the coffee (or other liquid beverage) produced by the machine.

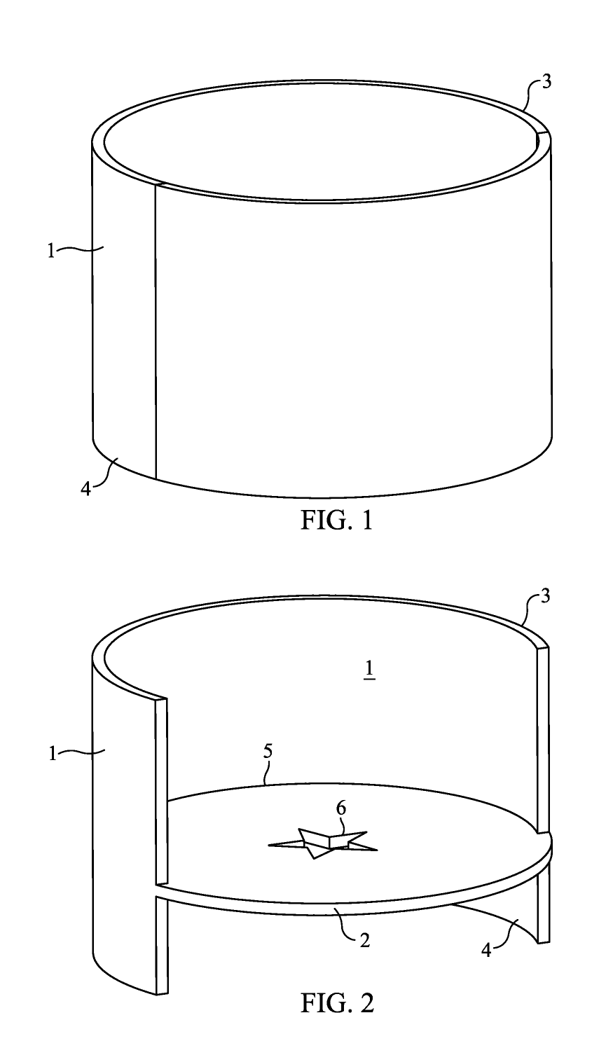

In one embodiment a dual-height platform is comprised of an outer wall land a shelf 2 (all Figures). The shelf 2 has a definitive area and perimeter. The outer wall 1 is joined to the shelf and projects orthogonally in opposite directions around the perimeter of the shelf 2. The shelf can be positioned at an upper end 3 or lower end 4 of the outer wall or positioned at a mid-point in the height of the outer wall 1. The outer wall 1 may orthogonally surround the entire perimeter of the shelf 2 (FIG. 1), or only surround a portion of the perimeter of the shelf to allow a cup handle to extend beyond the outer wall (FIG. 2). The outer wall 1 has a definitive height (H).

In one embodiment, the shelf 2 is positioned at a mid-height 5. If the mid height is other than one-half the total height of the outer wall 1, the location of the shelf 2 is not equidistant from the upper end 3 and lower end 4 of the outer wall 1. The shelf 2 may have one or more orifices 5 made therein. Said orifice(s) 5 allows for the passage of fluids, easier cleaning of the dual-height platform and decoration as desired. In a further embodiment a container can be included to fit under the orifice(s) to catch any spillage.

Disclosed and claimed is a multiple height platform includes a shelf with a perimeter and an outer wall contiguous along a portion of the perimeter of the shelf with an interior and exterior surface, and an upper end and a lower end creating a height of the outer wall. The shelf is positioned at a mid-point which is less than half of the height of the outer wall. The portion of the perimeter on which the outer wall is contiguous is less than the complete perimeter of the shelf creating a partial enclosure with an opening in the outer wall.

In one specific embodiment, the height (H) of the outer wall 1 is three (3) inches. The shelf is positioned two (2) inches from the upper end 3 and one inch from the lower end 4. In such an embodiment, the area of the shelf 2 and height (H) of the outer wall 1 is such that the enclosure, or partial enclosure created by the outer wall 1 is suitable to accommodate the base of a typical coffee mug or a drinking cup.

The multiple height platform can be configured in a rectangular shape, cylindrical shape, or other shape desired as long as it can fit under the liquid dispenser and hold the vessel to be filed with liquid. In one specific embodiment, the shelf 2 is in the shape of a circular disc. In such an embodiment, the diameter of the shelf 2 would preferably be three and one-half (3.5) inches.

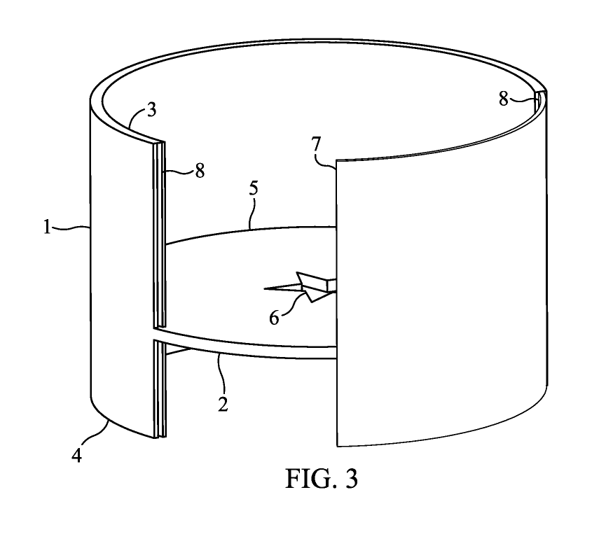

In another embodiment the outer wall 1 includes an extendable portion 7 configured to allow adjustment of the size of the opening in the wall. The extendable portion 7 can be mounted on the interior or outer surface of the outer wall 1 or configured to slide out of an outer wall pocket 8 in the outer wall 1 as shown on FIG. 3. The multiple height platform can be configured with one or more extendable portion(s).

In other embodiments a mechanism is provided to allow adjustment of the shelf height. In one such embodiment the outer wall is created in 2 pieces which are designed to be joined together after the shelf is positioned. The outer wall in this embodiment includes protrusions on the inner surface of the outer wall 1 at different heights from the bottom of the outer wall on which the shelf can rest. In another such embodiment the multiple height platform is configured with a shelf which can be ratcheted to any desired height. Many existing ratcheting devices are well known which can be used to accomplish the task of raising the shelf as desired.

To use the multiple height platform, the user positions it so that either the upper end 3 or the lower end 4 of the outer wall 1 rests on the tray of a liquid dispensing machine, such as a single-serve coffee machine. The multiple height platform is positioned directly beneath the liquid dispenser. The receptacle is then placed on the shelf 2, within the outer wall 1. To easily adjust the height of the receptacle relative to the dispenser, the multiple height platform is rotated such that the upper end 4 rests on the tray, and the receptacle is then placed on the shelf 2 within the outer wall 1.

The multiple height platform can be comprised of material(s) that is (are) suitable for use in a standard dishwasher. Possible materials include plastic, rigid cardboard, wood, and glass. The outer wall and shelf can be designed with names, advertising, logos, etc. as desired. The orifice can designed to any shape desired.

The above is a detailed description of particular embodiments of the invention. It is recognized that departures from the disclosed embodiments may be made within the scope of the invention and that obvious modifications will occur to a person skilled in the art. Those of skill in the art should, in light of the present disclosure, appreciate that many changes can be made in the specific embodiments which are disclosed herein and still obtain a like or similar result without departing from the spirit and scope of the invention. All of the embodiments disclosed and claimed herein can be made and executed without undue experimentation in light of the present disclosure.

1. A multiple height platform comprising:
a shelf with a perimeter;
an outer wall contiguous along a portion of the perimeter of the shelf with an interior and exterior surface, and an upper end and a lower end creating a height of the outer wall;
the shelf positioned at a mid-point which is less than half of the height of the outer wall; and
the portion of the perimeter on which the outer wall is contiguous is less than the complete perimeter of the shelf creating a partial enclosure with an opening in the outer wall.

2. The multiple height platform according to claim 1 further comprising at least one orifice in the shelf.

3. The multiple height platform according to claim 1 wherein the shelf and outer wall are rectangular in shape.

4. The multiple height platform according to claim 1 wherein the shelf and outer wall are cylindrical in shape.

5. The multiple height platform according to claim 4 wherein the height of the outer wall is three inches and the shelf is positioned two inches from the upper end of the outer wall.

6. The multiple height platform according to claim 1 in which the partial enclosure is configured to hold a vessel under a liquid dispenser in a liquid dispensing machine.

7. The multiple height platform according to claim 6 in which the liquid is coffee and the liquid dispensing machine is a coffee machine.

8. The multiple height platform according to claim 6 further comprising at least one orifice in the shelf.

9. The multiple height platform according to claim 6 wherein the shelf and outer wall are rectangular in shape.

10. The multiple height platform according to claim 6 wherein the shelf and outer wall are cylindrical in shape.

11. The multiple height platform according to claim 10 wherein the height of the outer wall is 3 inches and the shelf is positioned 2 inches from the upper end of the outer wall.

12. The multiple height platform according to claim 1 further comprising an extendable portion of the outer wall.

13. The multiple height platform according to claim 12 further comprising at least one orifice in the shelf.

14. The multiple height platform according to claim 12 in which the partial enclosure is configured to hold a vessel under a liquid dispenser in a liquid dispensing machine.

15. The multiple height platform according to claim 14 in which the liquid is coffee and the liquid dispensing machine is a coffee machine.

16. The multiple height platform according to claim 15 further comprising at least one orifice in the shelf.

17. The multiple height platform according to claim 16 wherein the shelf and outer wall are cylindrical in shape.

18. The multiple height platform according to claim 1 further comprising a mechanism to adjust the height of the shelf.
